(19) United States
(12) Patent Application Publication
(10) Pub. No.: US 2025/0349938 A1
(43) Pub. Date: Nov. 13, 2025

(54) LOW VOLTAGE BATTERY SIZE REDUCTION THROUGH ALTERNATING CURRENT HEATING USING UNIDIRECTIONAL AUXILIARY POWER MODULE

(71) Applicant: GM Global Technology Operations LLC, Detroit, MI (US)

(72) Inventors: Lei Hao, Troy, MI (US); Shuonan Xu, Troy, MI (US); Neeraj S. Shidore, Novi, MI (US); Dave Gerard Rich, Sterling Heights, MI (US); Suresh Gopalakrishnan, Troy, MI (US); Satish P. Ketkar, Troy, MI (US)

(21) Appl. No.: 18/662,296

(22) Filed: May 13, 2024

(51) Int. Cl. H01M 10/6571; B60L 58/27; B60R 16/033; H01M 10/615; H01M 10/625; H01M 10/63

(52) U.S. Cl. CPC H01M 10/6571; B60R 16/033; H01M 10/615; H01M 10/625; H01M 10/63; B60L 58/27; H01M 2220/20

(57) ABSTRACT

An electrical circuit heats a low voltage power source of a vehicle. The low voltage power source is coupled to a high voltage power source via a unidirectional auxiliary power module. The auxiliary power module is turned on during a first part of a heating period and off during a second part. During the first part, a first current flows through the low voltage power source in a first direction. During the second part, the first current is removed from the low voltage power source and a second current flows from the low voltage power source to a resistive load of the vehicle and in a second direction through the low voltage power source. A duty cycle of the heating period is selected so that a net charging power from the auxiliary power module is equal to a net discharging power to the resistive load over the heating period.

The subject disclosure relates to electrical systems in vehicles, and in particular to a system and method for heating a low voltage battery used in the vehicle.

An electric vehicle can include a high voltage power source for controlling high electrical load operations of the vehicle, such as propulsion systems, etc., and one or more low voltage power sources for controlling auxiliary devices, such as air conditioning, radio, windshield wipers, etc. When the vehicle has been exposed to low temperatures, the low voltage power source can have difficulty operating. Accordingly, it is desirable to provide a system and method for heating the low voltage power source.

### SUMMARY

In one exemplary embodiment, a method of heating a low voltage power source of a vehicle is disclosed. The low voltage power source is coupled to a high voltage power source via a unidirectional auxiliary power module. The unidirectional auxiliary power module is turned on during a first part of a heating period to flow a first current through the low voltage power source, wherein the first current flows in a first direction through the low voltage power source. The unidirectional auxiliary power module is turned off during a second part of the heating period to remove the first current from the low voltage power source. A second current is generated from the low voltage power source to a resistive load of the vehicle during the second part of the heating period. The second current flows through the low voltage power source in a second direction opposite the first direction. A duty cycle of the heating period is selected so that a net charging power from the unidirectional auxiliary power module is equal to a net discharging power to the resistive load over the heating period.

In addition to one or more of the features described herein, the method further includes disconnecting the resistive load from the low voltage power source during the first part of the heating period and connecting the resistive load is connected to the low voltage power source during the second part of the heating period.

In addition to one or more of the features described herein, the resistive load is continuously connected to the low voltage power source during the first part and the second part.

In addition to one or more of the features described herein, the method further includes selecting a duty cycle for the first part and the second part based on a load capacity of the resistive load.

In addition to one or more of the features described herein, the method further includes connecting a bypass resistor in parallel with the resistive load via a bypass switch.

In addition to one or more of the features described herein, the method further includes heating the low voltage power source such that one of a temperature of the low voltage power source cycles between a first temperature limit and a second temperature limit and the temperature is maintained at a selected value above a temperature threshold.

In addition to one or more of the features described herein, a battery current through the low voltage power source is a superposition of the first current and the second current, wherein the battery current has a waveform of one of a square wave, a trapezoidal wave, and a triangular wave.

In another exemplary embodiment, an electrical circuit for heating a low voltage power source of a vehicle is disclosed. The electrical circuit includes a high voltage power source, a unidirectional auxiliary power module that connects the high voltage power source to the low voltage power source, and a processor. The processor is configured to turn on the unidirectional auxiliary power module during a first part of a heating period to flow a first current through the low voltage power source, wherein the first current flows in a first direction through the low voltage power source and turn off the unidirectional auxiliary power module during a second part of the heating period to remove the first current from the low voltage power source, wherein a second current generated from the low voltage power source is supplied to a resistive load of the vehicle during the second part of the heating period, the second current flowing through the low voltage power source in a second direction opposite the first direction, wherein a duty cycle of the heating period is selected so that a net charging power from the unidirectional auxiliary power module is equal to a net discharging power to the resistive load over the heating period.

In addition to one or more of the features described herein, the processor is further configured to disconnect the resistive load from the low voltage power source during the first part of the heating period and connect the resistive load is connected to the low voltage power source during the second part of the heating period.

In addition to one or more of the features described herein, the resistive load is continuously connected to the low voltage power source during the first part and the second part.

In addition to one or more of the features described herein, the processor is further configured to select a duty cycle for the first part and the second part based on a load capacity of the resistive load.

In addition to one or more of the features described herein, the processor is further configured to connect a bypass resistor in parallel with the resistive load via a bypass switch.

In addition to one or more of the features described herein, the processor is further configured to heat the low voltage power source such that one of a temperature of the low voltage power source cycles between a first temperature limit and a second temperature limit and the temperature is maintained at a selected value above a temperature threshold.

In addition to one or more of the features described herein, a battery current through the low voltage power source is a superposition of the first current and the second current, wherein the battery current has a waveform of one of a square wave, a trapezoidal wave, and a triangular wave.

In yet another exemplary embodiment, a vehicle is disclosed. The vehicle includes a high voltage power source, a low voltage power source, a unidirectional auxiliary power module that connects the high voltage power source to the low voltage power source, a resistive load, and a processor. The processor is configured to turn on the unidirectional auxiliary power module during a first part of a heating period to flow a first current through the low voltage power source, wherein the first current flows in a first direction through the low voltage power source and turn off the unidirectional auxiliary power module during a second part of the heating period to remove the first current from the low voltage power source, wherein a second current generated from the low voltage power source is supplied to the resistive load during the second part of the heating period, the second current flowing through the low voltage power source in a second direction opposite the first direction, wherein a duty cycle of the heating period is selected so that a net charging power from the unidirectional auxiliary power module is equal to a net discharging power to the resistive load over the heating period.

In addition to one or more of the features described herein, the processor is further configured to disconnect the resistive load from the low voltage power source during the first part of the heating period and connect the resistive load is connected to the low voltage power source during the second part of the heating period.

In addition to one or more of the features described herein, the resistive load is continuously connected to the low voltage power source during the first part and the second part.

In addition to one or more of the features described herein, the processor is further configured to select a duty cycle for the first part and the second part based on a load capacity of the resistive load.

In addition to one or more of the features described herein, the processor is further configured to connect a bypass resistor in parallel with the resistive load via a bypass switch.

In addition to one or more of the features described herein, the processor is further configured to heat the low voltage power source such that one of a temperature of the low voltage power source cycles between a first temperature limit and a second temperature limit and the temperature is maintained at a selected value above a temperature threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, in accordance with an exemplary embodiment;

FIG. 2 shows a diagram including an electrical circuit of an electrical system of the vehicle, in an illustrative embodiment;

FIG. 3 shows a diagram of the electrical circuit being operated in a second heating process;

FIG. 4 is a graph showing a relation between a root mean square (RMS) battery current and a duty cycle for various load currents;

FIG. 5 is a graph illustrating a first control strategy for heating a low voltage power source; and

FIG. 6 is a graph illustrating a second control strategy for heating the low voltage power source.

### DETAILED DESCRIPTION

The following description is merely exemplary in nature and is not intended to limit the present disclosure, its application or uses. It should be understood that throughout the drawings, corresponding reference numerals indicate like or corresponding parts and features.

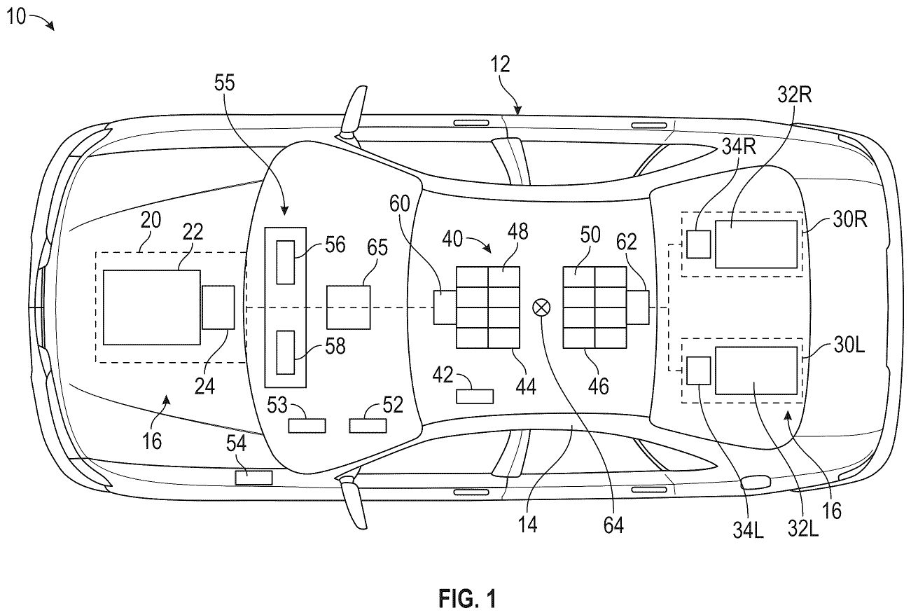

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads” or “resistive loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

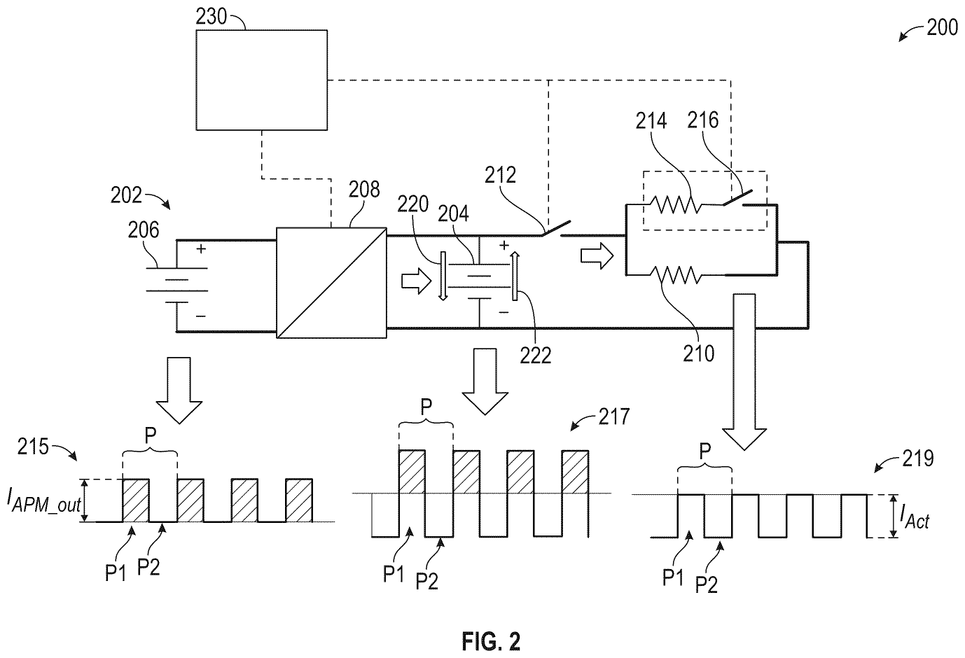

FIG. 2 shows a diagram 200 including an electrical circuit 202 of the electrical system of the vehicle 10, in an illustrative embodiment. The electrical circuit 202 includes a low voltage power source (LV power source 204) of the vehicle and circuit elements for heating the LV power source. The LV power source 204 can be a battery, such as a 12V battery, used in providing power to accessory loads of the electric vehicle, such as entertainment systems, air conditioning/heating, etc.

The electrical circuit 202 includes the LV power source 204, a high voltage power source (HV power source 206), an auxiliary power module (APM 208), a resistive load 210, and a heater switch 212 between the LV power source 204 and the resistive load 210. The HV power source 206 can be +400V, +800V or any suitable voltage value. The HV power source 206 can be +48V when the LV power source 204 is less than this voltage. The APM 208 is a unidirectional APM and can include a unidirectional DC-DC converter. The APM 208 connects the HV power source 206 to the LV power source 204 in a first circulation loop. The LV power source 204 and the resistive load 210 form a second circulation loop. A circuit controller 230 controls operation of the APM 208 and the heater switch 212. In various embodiments, the circuit controller 230 can be the controller 65.

The circuit controller 230 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The circuit controller 230 may include a non-transitory computer-readable medium that stores instructions which, when processed by one or more processors of the circuit controller 230, implement a method of performing a heating process for heating the LV power source 204, according to one or more embodiments detailed herein.

The electrical circuit 202 is operated in a first heating process that cycles back and forth between a first configuration (during a first part of a heating period) and a second configuration during a second part of the heating period). In the first configuration, the APM 208 is in an ON state and the heater switch 212 is open. Therefore, the HV power source 206 is connected to the LV power source 204, while the resistive load 210 is disconnected from the LV power source. In the second configuration, the APM 208 is in an OFF state and the heater switch 212 is closed. Therefore, the HV power source 206 is disconnected from the LV power source 204, while the resistive load 210 is connected to the LV power source.

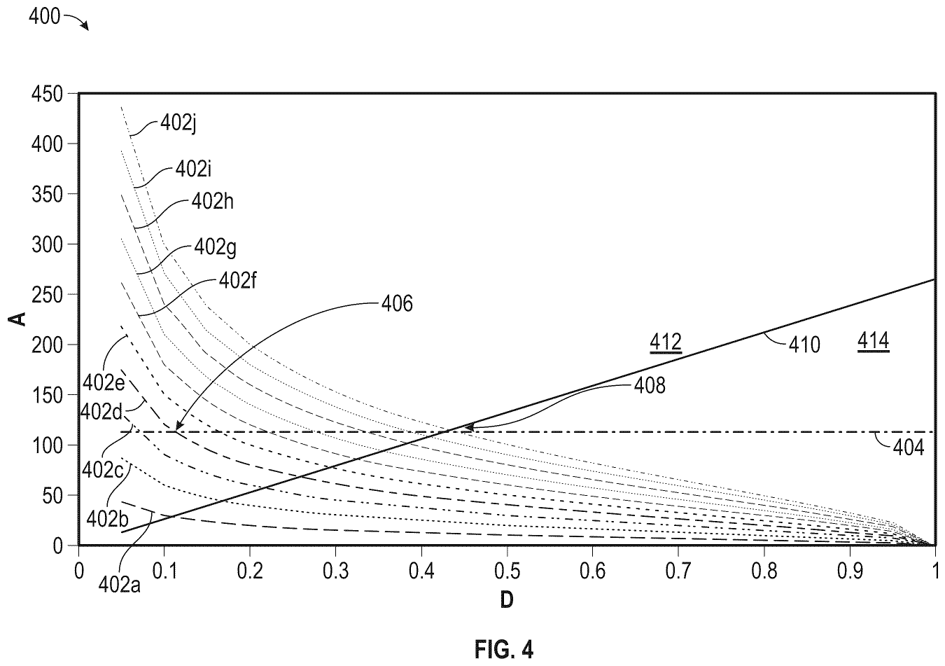

Graph 215 shows the waveform of a first current 220 (an APM current) flowing through the circuit as a result of operation of the APM 208. The graph 215 shows multiple heating periods. A heating period (P) includes a first part (P1) and a second part (P2). A duty cycle D (FIG. 4) defines a relative duration of the first part (P1) and the second part (P2). During the first part (P1) of a heating period (P), the APM is ON and the first current 220 is a positive value having a value I_{APM_out}. During the second part (P2) of the heating period (P), the APM is OFF and the first current 220 is zero. Due to the unidirectionality of the APM 208, the first current is always non-negative. The first current functions like a negative pulse through LV power source 204. In other words, the first current 220 flows through the LV power source in a first direction from positive terminal to negative terminal. The frequency and the magnitude of the first current 220 can be determined based on various parameters, such as an ambient temperature, battery parameters, etc.

Graph 217 shows the waveform of a second current 222 (a load current) through the resistive load 210 over multiple heating periods. During the first part (P1), the heater switch 212 is open and the second current 222 is zero. During the second part (P2), the second current 222 has a negative value I_{APM}. The second current 222 flows through the LV power source 204 in a second direction opposite the first direction (i.e., from the negative terminal to the positive terminal).

Graph 219 shows the waveform of battery current through the LV power source 204 over multiple heating periods. The battery current through the LV power source 204 is the superposition of the first current 220 and the second current 222. It is noted that the first current flows through the LV power source 204 from positive terminal to negative terminal, while the second current flows through the LV power source in the opposite direction (i.e., from negative terminal to positive terminal). Thus, the battery current can have a waveform in the form of a square wave. In alternative embodiments, the battery current can have a waveform in the form of a trapezoidal wave, and a triangular wave. The alternating flow of current through the LV power source produces heating at the LV power source 204, thereby heating the LV power source from a low temperature.

In various embodiments, a bypass resistor 214 can be placed in parallel with the resistive load 210 via a bypass switch 216. The bypass switch can be added into the electrical circuit 202 to control a magnitude of a load current (e.g., the magnitude of the second current 222). In general, the circuit controller 230 controls operation of the bypass switch 216.

Heat is generated at the LV power source 204 due to the flow of the battery current. In addition, the resistive load 210 can be a heater element which can be placed next to the LV power source 204 so that heat generated by the resistive load is used to heat the LV power source.

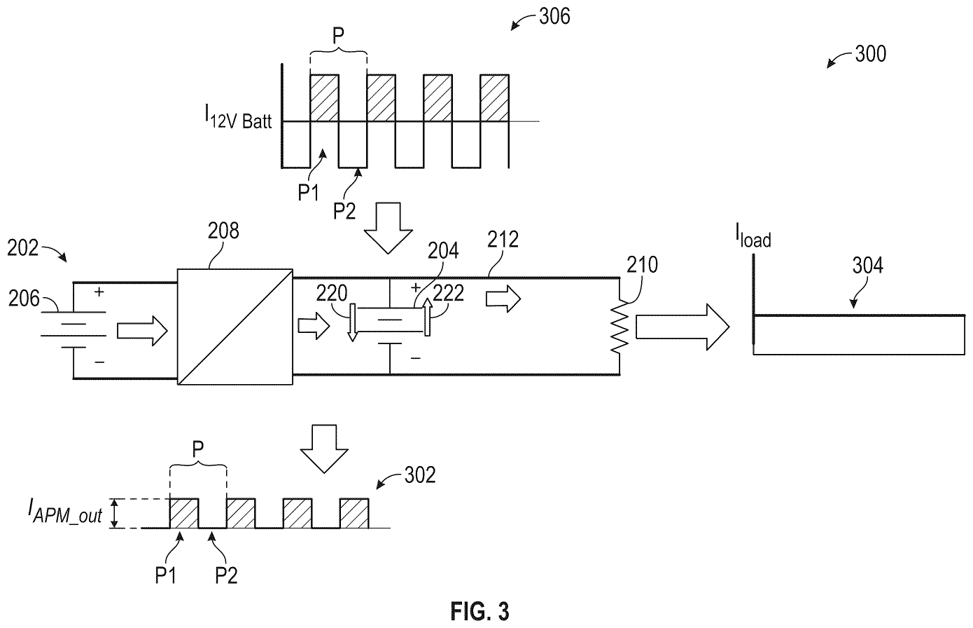

FIG. 3 shows a diagram 300 of the electrical circuit 202 being operated in a second heating process. The electrical circuit 202 includes the LV power source 204, the HV power source 206, the auxiliary power module (APM 208), and the resistive load 210. The electrical circuit 202 can include the heater switch 212, however this switch is held continuously in a closed position.

The second heating process includes cycling back and forth between a first configuration (during a first part of the heating period) and a second configuration (during a second part of the heating period). In the first configuration, the APM 208 is turned ON. During the second configuration, the APM 208 is turned OFF.

Graph 302 shows the waveform of the first current 220 over multiple heating periods. The first current 220 is the same or similar to the first current 220 shown in graph 215 of FIG. 2. The first current functions like a negative pulse through the LV power source 204, flowing in a first direction from positive terminal to negative terminal.

Graph 304 shows the waveform of a second current 222 through the resistive load 210 over multiple heating periods. The second current 222 is a DC negative current over both the first part and the second part. The second current 222 can be a constant current or can be varying.

Graph 306 shows the waveform of current through the LV power source 204 over multiple heating periods. The current oscillates between positive values and negative values over multiple heating periods.

While the first part P1 of the heating period P and the second part P2 of the heating period P are shown to be of equal duration in FIGS. 2 and 3, this is not meant to be a limitation. The duty cycle can be selected based on various parameters, as shown in FIG. 4 as long as the net charging power and net discharging power are equal over one heating period. In one embodiment the net charging power occurs during the first part of the heating period and net discharging power occurs during the second part of the heating period. The frequency of the heating period is greater than 300 Hz.

FIG. 4 is a graph 400 showing a relation between a root mean square (RMS) battery current and duty cycle for various load currents. Duty cycle D is shown as a ratio along the abscissa and RMS battery current is shown along the ordinate axis in amps (A). Curves 402ₐ-402ⱼ show the relation for respective load currents 10 A, 20 A, 30 A, 40 A, 50 A, 60 A, 70 A, 80 A, 90 A, and 100 A. Line 404 shows a desired RMS battery current of 113A which results in a heating rate of 1.25 C/min at −15 C ambient temperature for a 12V battery using an alternative current heating method. The desired RMS battery current can be obtained using several load currents. As indicated at first point 406, a load current of 40A with a duty cycle D of 0.12 can maintain this desired RMS battery current. As indicated at second point 408, a load current of 100A with a duty cycle D of 0.45 can maintain this desired RMS battery current. Due to a load capacity of the electrical load and the discharging capability of the LV power source 204, the load current (and thus the APM duty cycle) is limited. Feasibility line 410 indicates a load current limit for different duty cycles that do not exceed an APM limit. The region 412 above the feasibility line 410 is inaccessible to the circuit, while the region 414 below the feasibility line 410 can be accessed. Therefore, a processor operating the electrical circuit can choose the second point 408 to employ a duty cycle of D=0.45.

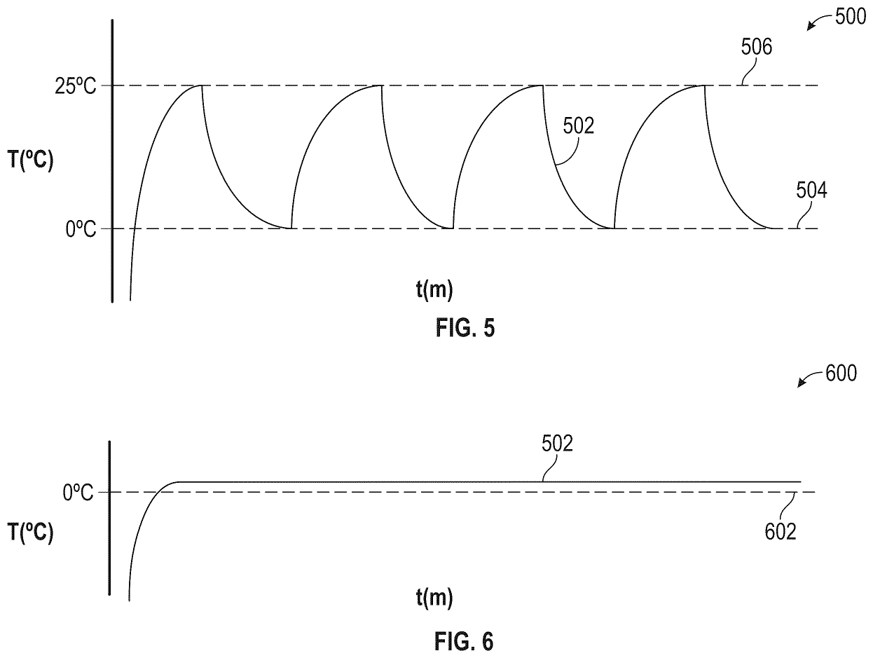

FIG. 5 is a graph 500 illustrating a first control strategy for heating the LV power source. Time is shown along the abscissa in minutes (min) and temperature is shown along the ordinate axis in degrees Celsius (° C.). The first control strategy cycles the temperature 502 of the LV power source 204 between a first temperature limit (low temperature limit 504) and a second temperature limit (high temperature limit 506). For illustrative purposes, the low temperature limit 504 is zero degrees Celsius (0° C.) and the high temperature limit 506 is 25° C. The heating process includes performing heating as shown in either FIG. 2 or FIG. 3 until the temperature reaches the high temperature limit 506. The heating is then halted until the temperature 502 cools to the low temperature limit 504, at which time the heating is resumed. This heating and cooling can be performed multiple times.

FIG. 6 is a graph 600 illustrating a second control strategy for heating the LV power source. Time is shown along the abscissa in minutes (min) and temperature is shown along the ordinate axis in degrees Celsius (° C.). The second control strategy maintains the temperature 502 of the LV power source at a selected value at or just above a temperature threshold 602. For illustrative purposes, the temperature threshold is zero degrees Celsius (0° C.).

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of heating a low voltage power source of a vehicle, comprising:
coupling the low voltage power source to a high voltage power source via a unidirectional auxiliary power module;
turning on the unidirectional auxiliary power module during a first part of a heating period to flow a first current through the low voltage power source, wherein the first current flows in a first direction through the low voltage power source;
turning off the unidirectional auxiliary power module during a second part of the heating period to remove the first current from the low voltage power source; and
generating a second current from the low voltage power source to a resistive load of the vehicle during the second part of the heating period, wherein the second current flows through the low voltage power source in a second direction opposite the first direction, wherein a duty cycle of the heating period is selected so that a net charging power from the unidirectional auxiliary power module is equal to a net discharging power to the resistive load over the heating period.

2. The method of claim 1, further comprising disconnecting the resistive load from the low voltage power source during the first part of the heating period and connecting the resistive load is connected to the low voltage power source during the second part of the heating period.

3. The method of claim 1, wherein the resistive load is continuously connected to the low voltage power source during the first part and the second part.

4. The method of claim 1, further comprising selecting a duty cycle for the first part and the second part based on a load capacity of the resistive load.

5. The method of claim 1, further comprising connecting a bypass resistor in parallel with the resistive load via a bypass switch.

6. The method of claim 1, further comprising heating the low voltage power source such that one of: (i) a temperature of the low voltage power source cycles between a first temperature limit and a second temperature limit; and (ii) the temperature is maintained at a selected value above a temperature threshold.

7. The method of claim 1, wherein a battery current through the low voltage power source is a superposition of the first current and the second current, wherein the battery current has a waveform of one of: (i) a square wave; (ii) a trapezoidal wave; and (iii) a triangular wave.

8. An electrical circuit for heating a low voltage power source of a vehicle, comprising:
a high voltage power source;
a unidirectional auxiliary power module that connects the high voltage power source to the low voltage power source;
a processor configured to:
turn on the unidirectional auxiliary power module during a first part of a heating period to flow a first current through the low voltage power source, wherein the first current flows in a first direction through the low voltage power source; and
turn off the unidirectional auxiliary power module during a second part of the heating period to remove the first current from the low voltage power source, wherein a second current generated from the low voltage power source is supplied to a resistive load of the vehicle during the second part of the heating period, the second current flowing through the low voltage power source in a second direction opposite the first direction, wherein a duty cycle of the heating period is selected so that a net charging power from the unidirectional auxiliary power module is equal to a net discharging power to the resistive load over the heating period.

9. The electrical circuit of claim 8, wherein the processor is further configured to disconnect the resistive load from the low voltage power source during the first part of the heating period and connect the resistive load is connected to the low voltage power source during the second part of the heating period.

10. The electrical circuit of claim 8, wherein the resistive load is continuously connected to the low voltage power source during the first part and the second part.

11. The electrical circuit of claim 8, wherein the processor is further configured to select a duty cycle for the first part and the second part based on a load capacity of the resistive load.

12. The electrical circuit of claim 8, wherein the processor is further configured to connect a bypass resistor in parallel with the resistive load via a bypass switch.

13. The electrical circuit of claim 8, wherein the processor is further configured to heat the low voltage power source such that one of: (i) a temperature of the low voltage power source cycles between a first temperature limit and a second temperature limit; and (ii) the temperature is maintained at a selected value above a temperature threshold.

14. The electrical circuit of claim 8, wherein a battery current through the low voltage power source is a superposition of the first current and the second current, wherein the battery current has a waveform of one of: (i) a square wave; (ii) a trapezoidal wave; and (iii) a triangular wave.

15. A vehicle, comprising:
a high voltage power source;
a low voltage power source;
a unidirectional auxiliary power module that connects the high voltage power source to the low voltage power source;
a resistive load;
a processor configured to:
turn on the unidirectional auxiliary power module during a first part of a heating period to flow a first current through the low voltage power source, wherein the first current flows in a first direction through the low voltage power source; and
turn off the unidirectional auxiliary power module during a second part of the heating period to remove the first current from the low voltage power source, wherein a second current generated from the low voltage power source is supplied to the resistive load during the second part of the heating period, the second current flowing through the low voltage power source in a second direction opposite the first direction, wherein a duty cycle of the heating period is selected so that a net charging power from the unidirectional auxiliary power module is equal to a net discharging power to the resistive load over the heating period.

16. The vehicle of claim 15, wherein the processor is further configured to disconnect the resistive load from the low voltage power source during the first part of the heating period and connect the resistive load is connected to the low voltage power source during the second part of the heating period.

17. The vehicle of claim 15, wherein the resistive load is continuously connected to the low voltage power source during the first part and the second part.

18. The vehicle of claim 15, wherein the processor is further configured to select a duty cycle for the first part and the second part based on a load capacity of the resistive load.

19. The vehicle of claim 15, wherein the processor is further configured to connect a bypass resistor in parallel with the resistive load via a bypass switch.

20. The vehicle of claim 15, wherein the processor is further configured to heat the low voltage power source such that one of: (i) a temperature of the low voltage power source cycles between a first temperature limit and a second temperature limit; and (ii) the temperature is maintained at a selected value above a temperature threshold.
